(19) United States
(12) Patent Application Publication
(10) Pub. No.: US 2018/0045178 A1
(43) Pub. Date: Feb. 15, 2018

(54) Air Capture Turbine

(71) Applicant: Gordon BELL, Ryhope (GB)

(72) Inventor: Gordon BELL, Ryhope (GB)

(21) Appl. No.: 15/557,181

(22) PCT Filed: Mar. 9, 2016
(86) PCT No.: PCT/GB2016/050639

§ 371 Date: Sep. 11, 2017

(30) Foreign Application Priority Data
Mar. 9, 2015 (GB) 1503929.0

(51) Int. Cl. F03D 3/04; F03D 3/02; F03D 15/20; F03D 9/25; F03D 9/32; F03D 9/34; F03D 3/00; F03D 7/06

(52) U.S. Cl. CPC F03D 3/0427; F03D 3/005; F03D 3/02; F03D 7/06; F03D 9/25; F03D 9/32; F03D 9/34; F03D 15/20; F05B 2240/9112; F05B 2240/931; F05B 2260/4031; F05B 2260/5032; F05B 2270/1011

(57) ABSTRACT

An air capture turbine comprises a centrifugal fan having a plurality of fan blades and a wall from which the blades extend, and a cowling having an inner wall. The centrifugal fan housed to the inside of the inner wall of the cowling. The centrifugal fan has a ring gear mounted on a lower side thereof, the turbine further comprising at least three energy converters, each including a gear wheel for engaging the ring gear. The weight of the centrifugal fan is supported by the at least three energy converters, and the inner wall of the cowling has a plurality of openings formed therein and closure members for selectively closing one or more of the plurality of openings, the openings providing or ingress and egress of air flowing in the direction of a prevailing wind to and from the centrifugal fan and the closure members protecting fan blades moving towards the direction of the prevailing wind from being engaged by air moving in that direction.

### FIELD OF THE INVENTION

The present invention is related the technical field of vertical axis wind turbines, and in particular to an air capture turbine with baffles for controlling the flow of air into and out of the turbine.

### BACKGROUND OF THE INVENTION

Vertical axis wind turbines are well known and are considered to be more effective in regions of turbulent wind than horizontal axis wind turbines. For this reason it is believed that vertical axis wind turbines can be used effectively in built up areas. However, vertical axis wind turbines have the disadvantage that whilst air travelling in a certain direction will exert a force on, the turbine that tends to cause the turbine to rotate in a first direction, that same air will also exert a force on other parts of the turbine resisting rotation of the turbine in the first direction.

One solution to the above-mentioned problem is to encase the turbine in a cowling, which permits entry of wind to drive the turbine but prevents wind that would resist rotation of the turbine from impinging thereon. One such device is described U.S. Pat. No. 7,235,893. In this device a squirrel cage fan is mounted on a central shaft and a cowling that partially covers the squirrel cage fan is also mounted on the central shaft. The open part of the cowling is positioned with respect to the squirrel cage by a wind vane extending from the cowling. The squirrel cage is supported on a buoyant hull (it is intended that the whole device be supported on a body of water) which also functions as a flywheel. Drive rollers are in frictional engagement with the outer wall of the hull and deliver power to electrical generators.

Another example is found in DE3913948. This document describes a vertical axis turbine having a wind guard, which in common with the device described in U.S. Pat. No. 7,235,893 is positioned by a wind that is connected to the guard. The vertical axis turbine is mounted on a support tower. A central shaft which extends through the support tower delivers power to a generator located at the base of the tower.

U.S. Pat. No. 6,270,308 describes a wind turbine that comprises both a turbine rotating about a horizontal axis and a turbine rotating about a vertical axis. The turbine that rotates about a vertical axis rotates about the support tower and is provided with a fairing that provides an air inlet and an air outlet. The fairing prevents wind that would act against rotation of the turbine from impinging thereon. The rotational energy of the vertical axis turbine is converted into electricity by generators. The generators sit to the outside of a bearing ring attached to the underside of the vertical axis turbine. The generators may be powered by frictional engagement with a wall of the bearing ring or the bearing ring may be constructed so that its inner face carries a toothed wheel, with a corresponding toothed wheel being connected to the generator.

The bearing ring is supported by bearings, each of which includes a wheel oriented at 45 degrees aura which is mounted on ball bearings. The fairing is also mounted on bearings so that the inlet thereof may align with the prevailing wind.

It would be desirable to provide an improved turbine.

It would also be desirable to provide a turbine that is configured for carbon capture.

### SUMMARY OF THE INVENTION

According to a first aspect of the invention there is provided an air capture turbine comprising a centrifugal fan having a plurality of fan blades and a wall from which the blades extend, and a cowling having an inner wall, the centrifugal fan housed to the inside of the inner wall of the cowling, wherein the centrifugal fan has a ring gear mounted on a lower side thereof, the turbine further comprising at least three energy converters, each including a gear wheel for engaging the ring gear, wherein the weight of the centrifugal fan is supported by the at least three energy converters, and wherein the inner wall of the cowling has a plurality of openings formed therein and closure members for selectively closing one or more of the plurality of openings, the openings providing for ingress and egress of air flowing in the direction of a prevailing wind to and from the centrifugal fan and the closure members protecting fan blades moving towards the direction of the prevailing wind from being engaged by air moving in that direction.

It is preferred that each opening in the outer wall is provided with guide members for guiding air to the opening, the guide members each presenting a larger opening than the said openings.

Advantageously, each opening is provided with a door which is moved between open and closed positions to open or close the opening with which the door is associated.

Preferably, the door may partially open the opening with which it is associated.

Preferably, the door is a sliding door.

Advantageously, the or each door slides in a space between the inner wall of the cowling and inner edges of the guide members.

Preferably, there are at least five openings.

Preferably, the energy converters are electricity generators

Advantageously, the ring gear and the gear wheel of the energy converters are bevelled, thereby centralizing the ring gear with respect to the gear wheels.

The air capture turbine may comprise a plurality of centrifugal fans mounted one on top of another. In such an arrangement one or more centrifugal fan may be provided with a ring gear on its upper side, said gearing for meshing with the ring gear of the lower side of another centrifugal fan.

In another embodiment the turbine includes or is attached to carbon capture means. Preferably, the or each opening is associated with a carbon capture means. Diverter means may be provided to divert a flow of air to or from the turbine to the carbon capture means.

According to another aspect of the invention there is provided a method of capturing carbon comprising the step of passing air egressing and/or egressing an air capture turbine according to the first aspect of the invention through a carbon capture system.

### BRIEF DESCRIPTION OF THE DRAWINGS

In the Drawings, which illustrate preferred embodiments of an air capture turbine according to the invention:

FIG. 1 is a schematic plan view of the turbine:

FIG. 1a is a schematic side view showing a detail of the turbine;

FIG. 1b is a schematic representation of an alternative form of a component of the turbine:

FIG. 2a is a schematic representation of the fan of the turbine illustrated in FIG. 1;

FIG. 2b is a schematic representation of an alternative configuration of fan of the turbine illustrated in FIG. 1;

FIG. 2c is a schematic representation of another alternative configuration of fan

FIG. 3 is a schematic representation of the cowling of the turbine illustrated in FIG. 1;

FIG. 4 is a schematic representation of the turbine in a first, configuration;

FIG. 5 is a schematic representation of the turbine in a second configuration;

FIG. 6 is a side view of a ship equipped with turbines according to the invention;

FIG. 7 is a side view of another ship equipped with turbines according to the invention;

FIG. 8 is a side view of a building having a number of turbines according to the invention mounted thereon; and

FIG. 9 is a side view of a cargo ship equipped with turbines according to the invention.

### DETAILED DESCRIPTION OF THE PREFERRED EMBODIMENTS

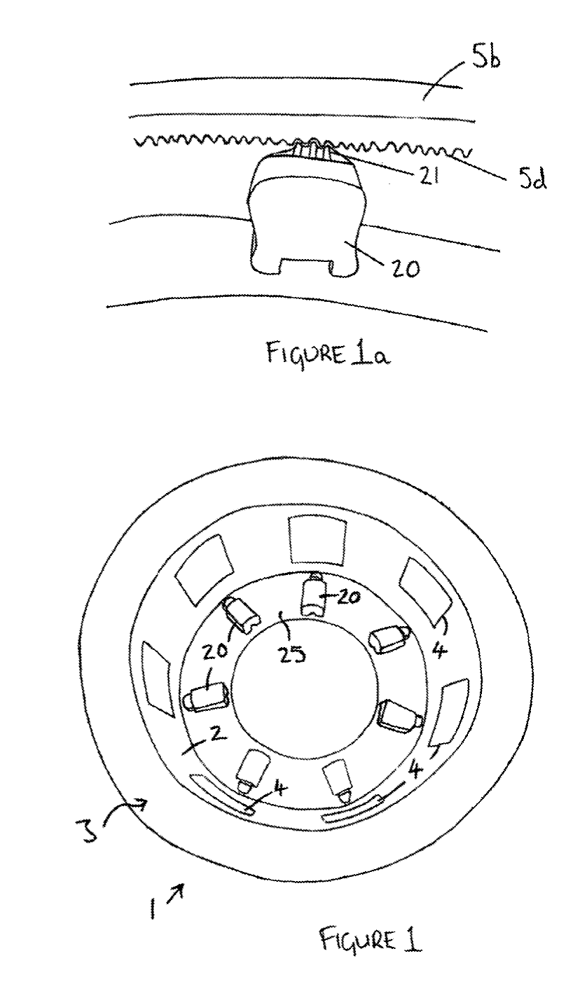

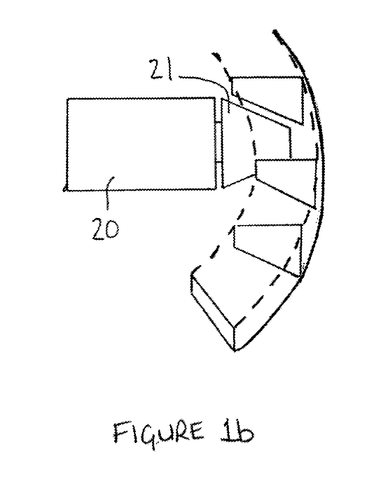

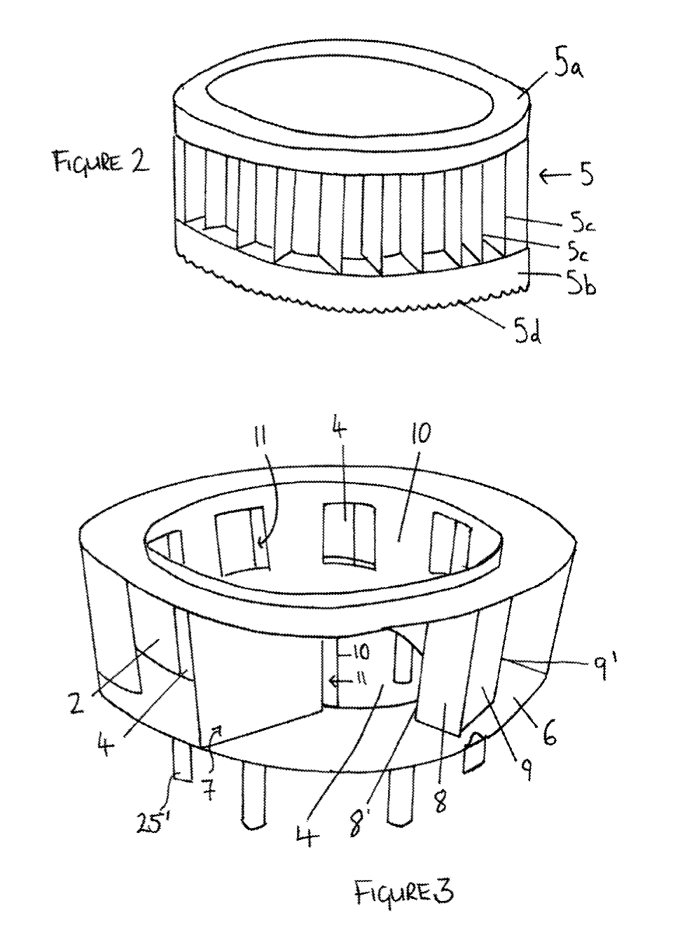

Referring now to FIGS. 1 to 3, the turbine comprises a cowling 1 in which a centrifugal fan 5 sits The cowling 1 has are inner wall 2 having a plurality of openings 4 therein. The cowling includes upper and lower wails 8, 6 and wind guides 7 which comprise first and second walls 8, 9. An inner edge 8′ of the first wall 8 and the inner edge 9′ of the second wall 9 terminate towards the inside of the cowling. A space 11 is formed between the inner edges 5′, 9′ of the walls 8, 9 and the inner wall 2 of the cowling. Each opening 4 is provided with a sliding door 10, which is situated in the space 11.

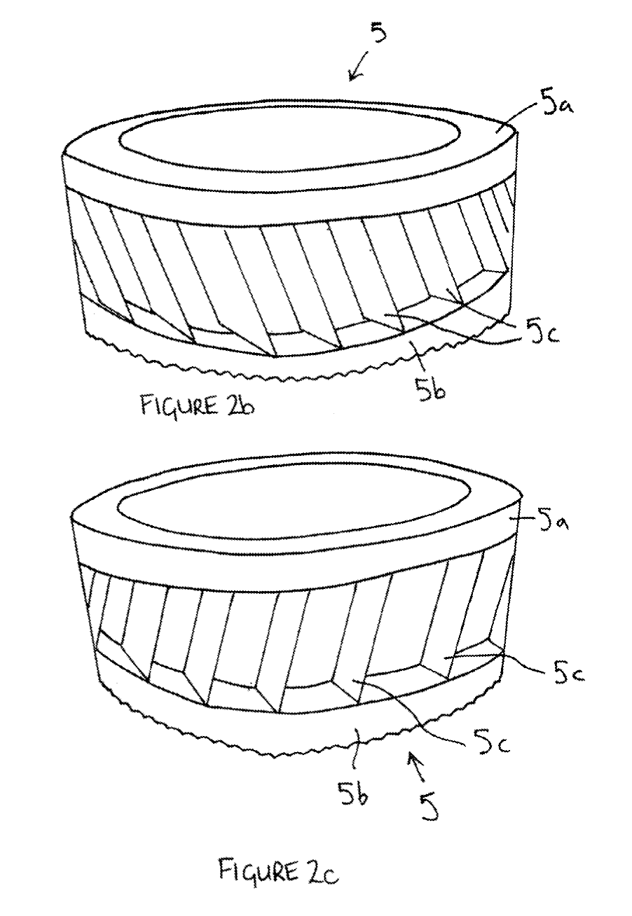

As can be seen from FIG. 2, the fan 5 comprises upper and lower ring beams 5a, 5b between which fan blades 5c extend. The lower ring beam 5b is provided with teeth 5d, the lower edge of the ring beam 5b therefore forming a ring gear. The fan 5 is supported by a plurality of electricity generators 20, each provided with a small gear wheel 21 mounted on a shaft of one of the generators 20, best shown in FIG. 1a. As can be seen fro FIG. 1, in the illustrated embodiment, the fan 5 is supported by seven generators 20. By providing a multiplicity of generators 20 it is possible that the fan 5 may be supported by the generators without additional bearing supports.

The teeth of gear wheel 21 and the teeth 5d of the ring gear may be bevelled, for example at 45 degrees, as shown in FIG. 1b. This has the advantage of self-centering the fan 5 on the gear wheels 21. Where the teeth of the gear wheel 21 and the ring gear are not bevelled other means to centre the fan 5 within the cowling 1 must be provided. For example, a plurality of rollers may be mounted on the underside of the lower wall 6, the rollers configured to engage the side of the ring beam 5b.

The generators 20 are supported by a suitably specified frame 25 which includes legs 25′.

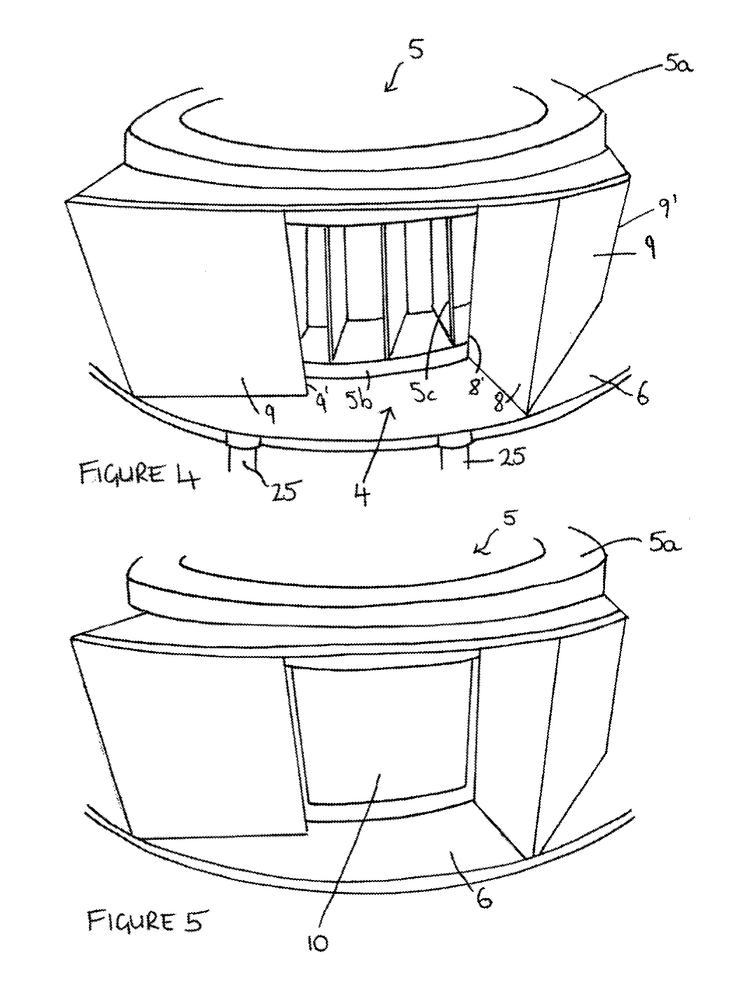

Referring specifically to FIG. 4, it will be appreciated that wind entering the opening 4 will exert a force on the blades 5c and that such a force will cause the fan 5 to rotate about its centre axis. Meshing of the gear teeth 5d of the ring gear with those of the gear wheel 21 mounted on a shaft which powers the generator 20 will cause that shaft to rotate and hence the generator 20 to generate electricity.

The cowling 1 provides only one path for entering the cowling. Wind enters the turbine through those openings 4 on the windward side of the cowling 1 that are open, with a corresponding number of openings 4 on the leeward side of the cowling also open. As discussed above, the openings 4 are opened or closed by sliding the doors 10 in the space 11. The turbine may include actuators and control means for opening and closing the doors 10, and control of which doors 10 are open and which are closed may be controlled automatically according to the direction of the prevailing wind.

It is known that when wind speeds exceed a certain threshold it is necessary to shut down a wind turbine. In the present invention this may be achieved by closing all the doors 10. However, by providing for the control of air through the turbine, it is possible that the turbine may be allowed to run when wind speeds exceed the threshold at which it would normally be considered necessary to shut down the turbine. This is because it the doors may be partially closed to throttle the flow of air into and out of the turbine. In such a circumstance, the doors 10 that would be closed due to the direction of the prevailing wind would be closed, and the doors 10 that would be open would only be partially open.

It may be advantageous to reduce the load on the generators 20. FIGS. 2b and 2c illustrate fans 5 adapted to reduce the load on the generators 20. The fan blades 5c lie at an angle to the vertical. Hence, wind encountering the fan blades will exert forces on the fan 5 having horizontal and vertical components. The vertical force component will tend to lift the fan 5, thereby reducing the weight to be supported by the generators. Of course, this reduces the amount of force available for rotating the fan 5 and hence reduces the amount of electricity that can be generated by the turbine. Alternative means of lifting the fan may be provided. For example, magnets or electro-magnetic forces may be used.

The turbine of the invention confines the air used to rotate the fan, that is all the air driving the fan 5 enters and leaves the cowling 1. This air entering and/or leaving (most suitably leaving) the turbine of the invention may therefore be passed through a carbon capture system. Any carbon capture system used for extracting carbon from a body of air may be utilised.

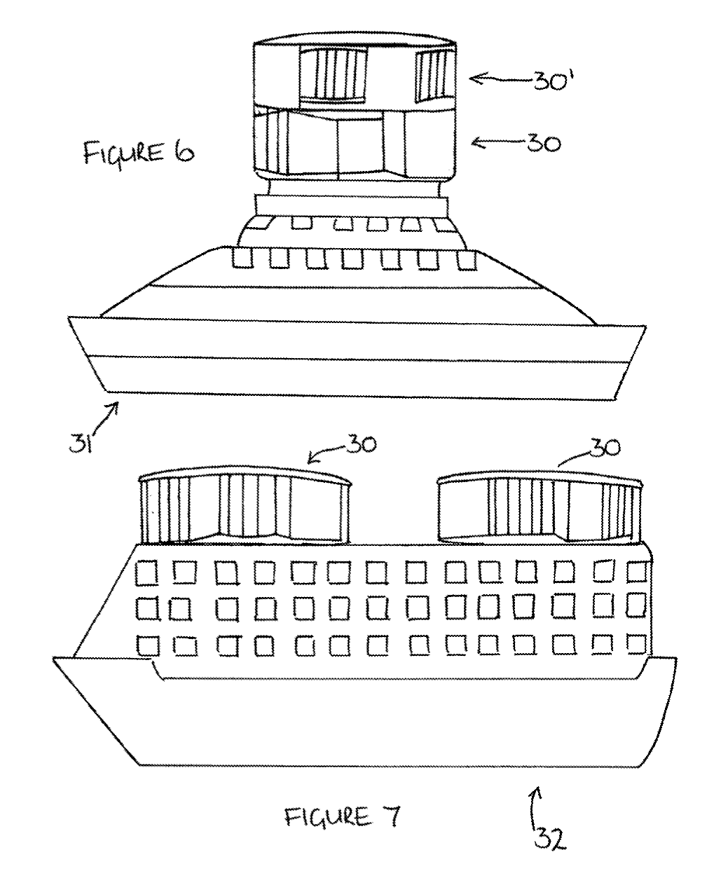

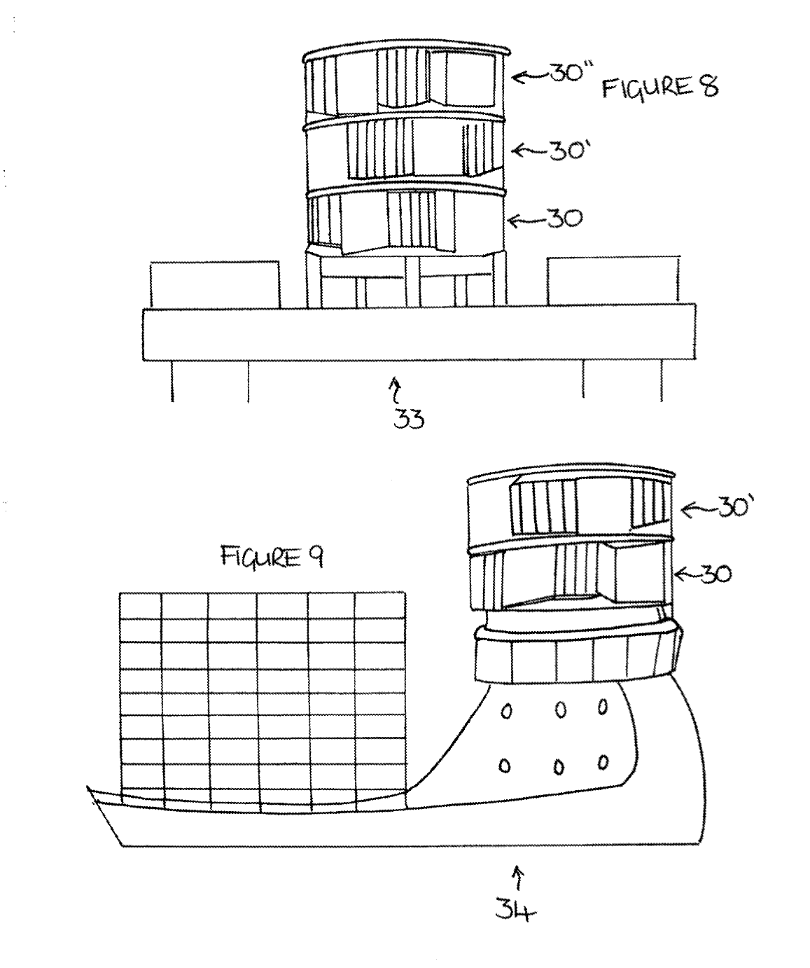

FIGS. 6 to 9 show the turbines 30, 30′ of the invention mounted on ships 31, 32, 34 and on a building 33. The turbines 30 mounted on the ships 31 and 33, and on the building 33 are stacked one on top of the other. In this arrangement the lower turbine is a turbine of the type shown in FIGS. 1 to 5. The turbines 30′ mounted on top of either the turbine 30 or another turbine 30′ differ may slightly. In the turbines 30′, instead of the fan 5 being supported on the generators 20, it is supported by the bearing ring 5a of the fan 5 of the turbine on which it sits. In this configuration the bearing ring 5a is provided with teeth in a similar manner to the lower bearing ring 5b. Such gear teeth of the ring 5a may also be bevelled so that the fan 5 of the turbine 30′ remains centralised on the fan 5 of the turbine 30. In FIG. 8, where there are two turbines 30′, the upper ring gear 5a of the first turbine 30′ should also be provided with gear teeth to mesh with the gear teeth 5d of the fan 5 of the upper most turbine 30.

The cowlings 1 of the turbines 30, 30′ may be bolted together, or other fastening means or constraining means may be provided so that the said cowlings 1 of the respective turbines do not move with respect to one another.

The turbine of the invention overcomes the problem of the driving wind actually slowing down the turbine, and does so with few moving parts. In fact where the fan 5 is supported on the generators themselves much power transmission gear may be omitted. The turbines may be used on ships and buildings to provide power close to the point of consumption.

1. An air capture turbine comprising a centrifugal fan having a plurality of fan blades and a wall from which the fan blades extend, and a cowling having an inner wall, the centrifugal fan housed to an inside of the inner wall of the cowling, wherein the centrifugal fan includes upper ring beam and lower ring beam each joined to the wall, the fan blades extending between the upper ring beam and lower ring beam, and a ring gear mounted on a lower side of the lowering beam, the air capture turbine further comprising at least three electrical energy generators, each including a gear wheel for engaging the ring gear, wherein the weight of the centrifugal fan is supported by the at least three energy converters, and wherein the inner wall of the cowling has a plurality of openings formed therein and a respective closure members associated with each one of the plurality of openings for selectively closing a selected one of the plurality of openings, the each of the plurality of openings providing for ingress and egress of air flowing in the direction of a prevailing wind to and from the centrifugal fan and the closure members closing openings between said openings providing for ingress and egress of air flowing in the direction of the prevailing wind and protecting fan blades moving towards the direction of the prevailing wind from being engaged by air moving in that direction, and wherein the wall and upper ring beam and lower ring beam of the centrifugal fan and the cowling together confine air driving rotation of the fan.

2. An air capture turbine according to claim 1, wherein each opening in the outer wall is provided with guide members for guiding air to the opening, the guide members each presenting a larger opening than the said openings.

3. An air capture turbine according claim 1, wherein , each opening is provided with a d our which is moved between open and closed positions to open or close the opening with which the door is associated.

4. An air capture turbine according to claim 3, wherein the door may partially open the opening with which it is associated.

5. An air capture turbine according to claim 3, wherein the door is a sliding door.

6. An air capture turbine according to claim 3, wherein each opening in the outer wall is provided with guide members for guiding air to the opening, the guide members each presenting a larger opening than the said openings and each door slides in a space between the inner wall of the cowling and inner edges of the guide members.

7. An air capture turbine according to claim 1, wherein there are at least five openings.

8. An air capture turbine according to claim 1, wherein the energy converters are electricity generators.

9. An air capture turbine according to claim 1, wherein the ring gear and the gear wheel of the energy converters are bevelled.

10. An air capture turbine according to claim 1, comprising a plurality of centrifugal fans mounted one on top of another.

11. An air capture turbine according to claim 10, wherein, one or more centrifugal fan is provided with a ring gear on its upper side, said ring gear for meshing with the ring gear of the lower side of another centrifugal fan.

12. An air capture turbine according to claim 10, wherein each fan is provided with its own cowling, or each fan is housed in a common cowling.

13. An air capture turbine according to claim 1, further comprising carbon capture means.

14. An air capture turbine according to claim 13, wherein the or each opening is associated with a carbon capture means.

15. An air capture turbine according to claim 13, further comprising diverter means to divert a flow of air to or from the turbine to the carbon capture means.

16. A method of capturing carbon comprising the step of passing air egressing;and/or egressing an air capture turbine according to claim 1.

17. An air capture turbine according to claim 1, wherein the wall and upper ring beam and lower ring beam of the centrifugal fan and the cowling together confine air driving rotation of the fan to enter via an opening in the windward side of the cowling and to leave via an opening in a leeward side of the cowling.

18. A method of capturing carbon according to claim 17, wherein the or each opening is associated with a carbon capture means.

19. A method of capturing carbon according to claim 17, comprising the further step of diverting a flow of air to or from the turbine to the carbon capture means.
